(19) United States
(12) Patent Application Publication
(10) Pub. No.: US 2016/0062443 A1
(43) Pub. Date: Mar. 3, 2016

(54) ELECTRONIC DEVICE AND METHOD

(71) Applicant: KABUSHIKI KAISHA TOSHIBA, Tokyo (JP)

(72) Inventors: Ryo SAITO, Tokyo (JP); Jun WATANABE, Fussa Tokyo (JP); Toshikazu MUKAIYAMA, Nishitama Tokyo (JP); Keiichi MITSUI, Kokubunji Tokyo (JP)

(21) Appl. No.: 14/712,782

(22) Filed: May 14, 2015

(30) Foreign Application Priority Data
Aug. 29, 2014 (JP) 2014-175728

(51) Int. Cl. G06F 1/32

(52) U.S. Cl. CPC G06F 1/3231; G06F 1/3234

(57) ABSTRACT

In one embodiment, an electronic device detachably connected to a mobile device is provided. The electronic device of the embodiment includes a power supply, a detector and a controller. The power supply is configured to supply power to the mobile device when the mobile device is connected to the electronic device. The detector is configured to detect whether a user is within the detector's range. The controller is configured to stop supplying power to the mobile device, when the detector detects a user while the mobile device is connected to the electronic device and to subsequently resume supplying power.

### CROSS-REFERENCE TO RELATED APPLICATIONS

This application is based upon and claims the benefit of priority from Japanese Patent Application No. 2014-175728, filed Aug. 29, 2014, the entire contents of which are incorporated herein by reference.

### FIELD

Embodiments described herein relate generally to an electronic device and a method.

### BACKGROUND

Recently, mobile devices such as tablet computers have made great inroads into the home, the workplace, the schoolroom and other settings. On such a mobile device, according to operation of the mobile device by the user, it is possible to display various kinds of information desired to be seen by the user.

Since the main mode of use of the mobile device is the above-described information display according to operation by the user, the mobile device is not necessarily used efficiently.

In other words, by presenting (displaying) various kinds of information to the user even when, for example, the user is not performing any operations, that is, even when there is no intention by the user, the mobile device can be used more efficiently.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of an example of an exterior appearance of a cradle of an embodiment.

FIG. 2 is a perspective view of an external appearance of a tablet computer to be seated in the cradle.

FIG. 3 is a perspective view of an example of a state where the tablet computer is seated in the cradle.

FIG. 4 illustrates an example of a system configuration of the cradle.

FIG. 5 illustrates an example of a system configuration of the tablet computer.

FIG. 6 is a block diagram mainly showing an example of a function configuration of the cradle and the tablet computer.

FIG. 7 is a flowchart showing an example of a procedure of the cradle.

FIG. 8 is a drawing explaining the turning on and turning off of the screen of the tablet computer.

### DETAILED DESCRIPTION

Various embodiments will be described hereinafter with reference to the accompanying drawings.

In general, according to one embodiment, an electronic device detachably connected to a mobile device is provided. The electronic device includes a power supply, a detector and a controller. The power supply is configured to supply power to the mobile device when the mobile device is connected to the electronic device. The detector is configured to detect whether a user is within the detector's range. The controller is configured to stop supplying power to the mobile device, when the detector detects a user while the mobile device is connected to the electronic device and to subsequently resume supplying power.

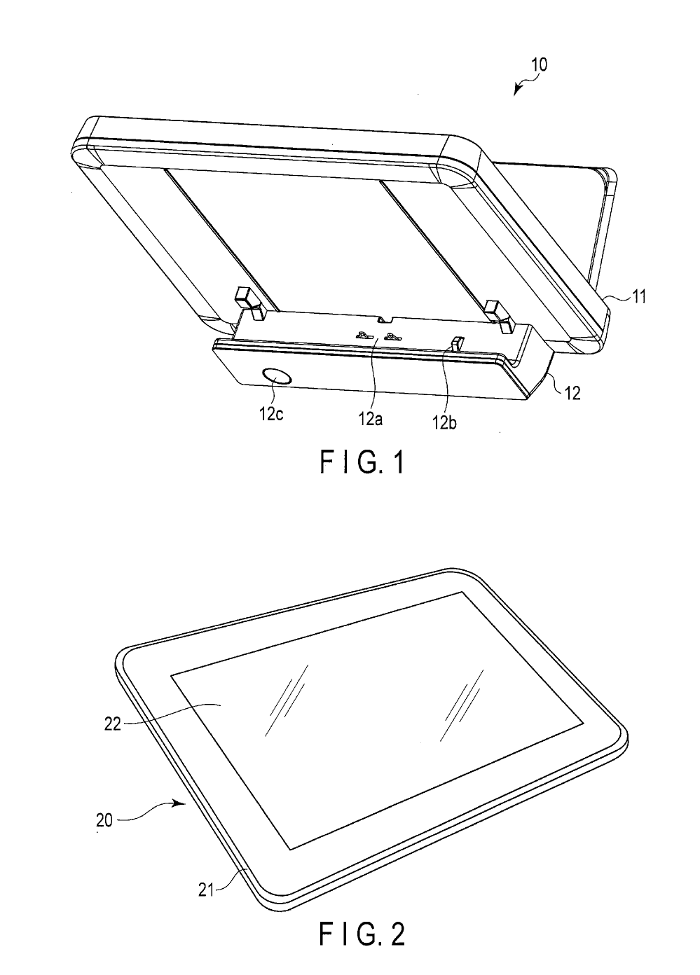

FIG. 1 is a perspective view of an example of an exterior appearance of an electronic device of the present embodiment. The electronic device of FIG. 1 is a device called, for example, a cradle. In the following descriptions, the electronic device of the present embodiment will be referred to as a cradle.

A cradle 10 of FIG. 1 is a desktop cradle designed to be placed, for example on a table, a desk or the like. As illustrated in FIG. 1, the cradle 10 includes a rest 11 and a seat 12. With these, the cradle 10 is detachably connected to the mobile device. More specifically, the cradle 10 is configured such that the mobile device can be seated therein by placing the device in the seat 12 and propping it against the rest 11. Note that the mobile device to be seated in the cradle 10 includes, for example, a tablet computer, a smartphone, a PDA or the like. The following descriptions are given that the mobile device to be seated in the cradle 10 is a tablet computer.

Further, in the seat 12, charging contacts 12a, a switch 12b and a biopresence sensor 12c (pyroelectric sensor) are provided.

The charging contacts 12a are provided, for example, on the upper surface of the seat 12 as shown in FIG. 1, and the charging contacts 12a electrically connect the cradle 10 and the tablet computer when the tablet computer is seated in the cradle 10. In this way, it is possible to supply power from the cradle 10 to the tablet computer seated in the cradle 10, and thus the tablet computer can be charged by using the cradle 10.

The switch 12b is provided in such a position (on the upper surface of the seat 12 in the case of the example shown in FIG. 1) as to be actuated by the tablet computer when the tablet computer is seated in the cradle 10. When this switch 12b is actuated as the tablet computer is seated in the cradle 10, the cradle 10 is powered on to start the above-described charging of the tablet computer or the like.

The biopresence sensor 12c is supported, for example, on the front surface of the seat 12 as shown in FIG. 1. The biopresence sensor 12c is a sensor for detecting the presence of a person in proximity to the biopresence sensor 12c (that is, in the vicinity of the cradle 10).

Here, FIG. 2 is a perspective view of an example of the exterior appearance of the tablet computer to be seated in the cradle 10 of FIG. 1. A tablet computer 20 of FIG. 2 includes a body 21 and a touchscreen display 22.

The body 21 has a thin box-shaped housing. In the touchscreen display 22, a flat panel display and a sensor which is configured to detect a contact position of a finger or the like on the screen of the flat panel display are incorporated. The flat panel display includes, for example, an LCD or the like. The sensor includes, for example, a touchpanel or the like. In this case, a touchpanel is provided in such a manner as to cover the LCD.

Even though not shown in FIG. 2, for example, a power button for powering the tablet computer 20 on and off, a micro-USB socket and the like are provided in the side surface of the tablet computer 20. Note that, if the above-described cradle 10 is not used for charging the tablet computer 20, it is also possible to charge the tablet computer 20 by, for example, inserting the other plug (micro-USB plug) of a USB cable, one plug of which is inserted into a micro-USB power adaptor or the like, into a micro-USB socket provided in the tablet computer 20. The USB power adaptor is an external power-supply apparatus having a USB socket.

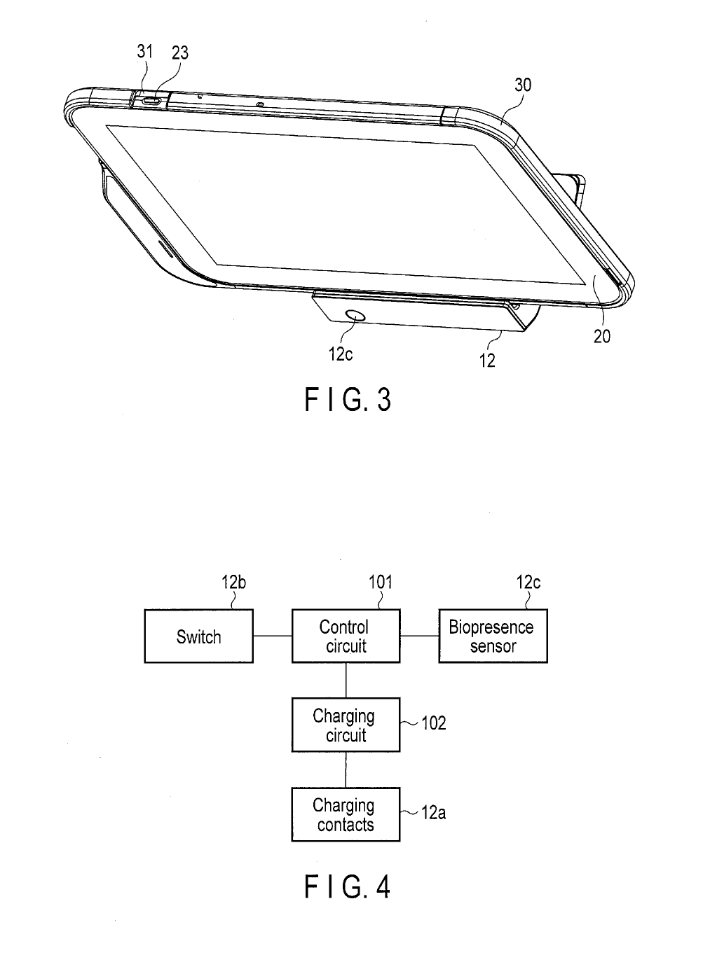

FIG. 3 is a perspective view of an example of a state where the above-described tablet computer 20 of FIG. 2 is seated in the cradle of FIG. 1.

As illustrated in FIG. 3, the tablet computer 20 is seated in the cradle 10 in such a state where, for example, a cover unit 30 is attached thereto.

Although not shown in the drawing, a micro-USB plug is provided in the inner surface of the cover unit 30, and the cover unit 30 is attached in such a state where the micro-USB plug is inserted into the micro-USB socket provided in the side surface of the tablet computer 20. In this way, the tablet computer 20 and the cover unit 30 are connected with each other.

Further, on the side surface of the cover unit 30 (in a position contacting the charging contacts 12a provided in the cradle 10 when the tablet computer 20 to which the cover unit 30 is attached is seated in the cradle 10), charging contacts (not shown) are provided.

In this way, when the tablet computer 20 to which the cover unit 30 is attached is seated in the cradle 10, the charging contacts on the side surface of the cover unit 30 and the charging contacts 12a on the upper surface of the seat 12 in the cradle 10 make contact, and thus it is possible to electrically connect the cover unit 30 and the cradle 10.

That is, in the present embodiment, when the tablet computer 20 is seated in the cradle 10, the cradle 10 and the tablet computer 20 are electrically connected with each other via the cover unit 30 attached to the tablet computer 20.

By preparing the cover unit 30 for each of various kinds of tablet computers 20, it is possible to seat a tablet computer 20 of a different size, shape and the like in the cradle 10.

Here, a case where the tablet computer 20 to which the cover unit 30 is attached is seated in the cradle 10 has been described, but the tablet computer 20 may be seated directly in the cradle 10 as long as the cradle 10 and the tablet computer 20 can be electrically connected with each other when the tablet computer 20 is seated in the cradle 10.

Note that the tablet computer 20 to which the cover unit 30 is attached is seated in the cradle 10 in the present embodiment as described above, but for the sake of convenience, the following descriptions are given that the tablet computer 20 alone is seated in the cradle 10.

Further, as illustrated in FIG. 3, an opening 31 is appropriately provided in the cover unit 30. With this structure, even in a state where the cover unit 30 is attached to the tablet computer 20, it is still possible to perform an operation of a power button 23 or the like provided on the side surface of the tablet computer 20.

FIG. 4 illustrates an example of a system configuration of the cradle 10. As illustrated in FIG. 4, the cradle 10 includes, for example, a control circuit 101, a charging circuit 102 and the like in addition to the above-described charging contacts 12a, switch 12b and biopresence sensor 12c.

The control circuit 101 is configured as, for example, a single-chip microcomputer to execute various kinds of control in the cradle 10. The control circuit 101 connects to the switch 12b, the biopresence sensor 12c, the charging circuit 102 and the like.

The charging circuit 102 is a circuit for charging the tablet computer 20 by, for example, supplying power supplied from an external power-supply apparatus such as a USB power adaptor connected to the cradle 10 to the tablet computer 20 seated in the cradle 10. Note that power from an external power-supply apparatus is supplied via the charging contacts 12a.

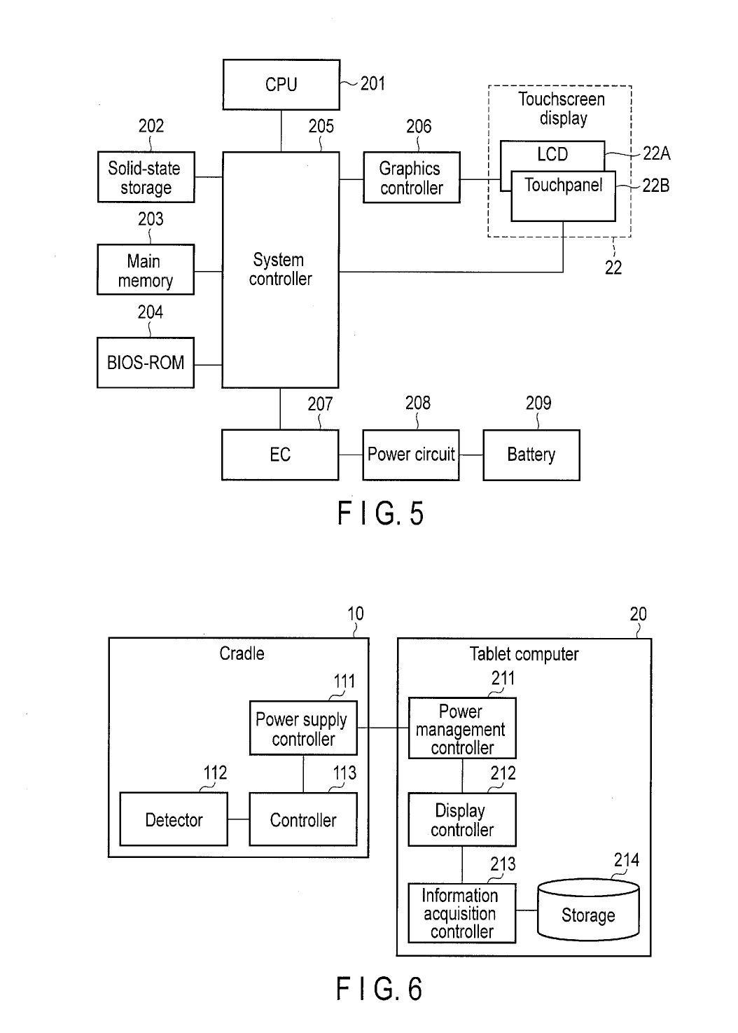

FIG. 5 illustrates an example of a system configuration of the tablet computer 20 to be seated in the cradle 10. As illustrated in FIG. 5, the tablet computer 20 includes, for example, a CPU 201, solid-state storage 202, a main memory 203, a BIOS-ROM 204, a system controller 205, a graphics controller 206, an EC 207, a power circuit 208, a battery 209 and the like in addition to the above-described touchscreen display 22. Further, the touchscreen display 22 includes an LCD 22A and a touchpanel 22B.

The CPU 201 is a processor configured to control the operation of each component in the tablet computer 20. The CPU 201 executes various kinds of software loaded into the main memory 203 from a storage device, namely, the solid-state storage 202. The software includes an operating system (OS) and various application programs.

The CPU 201 also executes a basic input/output system (BIOS) stored in the BIOS-ROM 204. The BIOS is a program for hardware control.

The system controller 205 is a device configured to connect a local bus of the CPU 201 and various components. The system controller 205 includes a built-in memory controller configured to perform access control of the main memory 203. The system controller 205 also includes a function of performing communication with the graphics controller 206 via a serial bus conforming to the PCI Express standard or the like.

The graphics controller 206 is a display controller configured to control the LCD 22A used as the display monitor of the tablet computer 20. The graphics controller 206 generates a display signal and transmits it to the LCD 22A. The LCD 22A displays a screen image based on the display signal. The touchpanel 22B is, for example, a capacitive pointing device for performing input on the screen of the LCD 22A. For example, a contact position touched by the user's finger on the screen, the movement of the contact position and the like are detected by the touchpanel 22B. With the touchpanel 22B, it is possible to operate a graphical user interface or the like displayed on the screen of the LCD 22A.

The EC 207 is a single-chip microcomputer including an embedded controller for power management. The EC 207 includes a function of powering the tablet computer 20 on and off based on an operation of the power button 23 by the user.

The power circuit 208 generates power to be supplied to each component in the tablet computer 20 by, for example, using power supplied from the battery 209.

Note that the above-described power button 23, micro-USB socket and the like are omitted in FIG. 5.

FIG. 6 is a block diagram mainly showing an example of a function configuration of the cradle 10 of the present embodiment and the tablet computer 20 to be seated in the cradle 10.

As illustrated in FIG. 6, the cradle 10 includes a power supply controller 111, a detector 112 and a controller 113.

The power supply controller 111 is a functional module realized by the charging circuit 102 provided in the above-described cradle 10. The power supply controller 111 is configured to supply power (for charging the battery 209 for example) to the tablet computer 20 when the tablet computer 20 is seated in the cradle 10.

The detector 112 is a functional module realized by the biopresence sensor 12c provided in (the seat 12 in) the cradle 10, and is configured to detect the presence of a person in the vicinity of the cradle 10 (that is, whether a user is within the detector's range).

The controller 113 is a functional module realized by the control circuit 101 provided in the cradle 10. The controller 113 is configured, when the presence of a person is detected by the detector 112 while the tablet compute 20 is seated in the cradle 10 as described above, to execute control to temporarily stop (cut off) the power supply by the power supply controller 111 and subsequently resume (start) the power supply.

Further, as illustrated in FIG. 6, the tablet computer 20 includes a power management controller 221, a display controller 212, an information acquisition controller 213 and a storage 214.

The power management controller 211 is a functional module for managing power supply to the entire tablet computer 20. The power management controller 221 charges the battery 209 by using power supplied by the power supply controller 111 included in the cradle 10 when the tablet computer 20 is seated in the cradle 10. Further, when this charging of the battery 209 is started, the power management controller 211 notifies so to the display controller 212.

Here, in the present embodiment, the tablet computer 20 has a function of turning the screen (touchscreen display 22) of the tablet computer 20 on (hereinafter referred to as a display auto-on function) at the start of charging the battery 209 so as to present, for example, the remaining capacity of the battery 209 or the like to the user. With this function, when the controller 113 included in the above-described cradle 10 executes control to temporarily stop the power supply by the power supply controller 111 and subsequently resume the power supply, the screen of the tablet computer 20 is automatically turned on, and thus it becomes possible to display various kinds of information.

Further, the tablet computer 20 has a function of automatically turning the screen of the tablet computer 20 off (hereinafter referred to as a display auto-off function) if no operation is performed on the tablet computer 20 while the screen of the tablet computer 20 is on. Note that the following descriptions assume that the length of time before the screen is automatically turned off (hereinafter referred to as the display timeout) is set in advance in the tablet computer 20. Further, the display timeout is managed by using an internal clock in the tablet computer 20.

The display controller 212 executes control to switch between the screen of the tablet computer 20 being on or off (that is, between an on-state and an off-state).

Further, when it is notified by the power management controller 211 that charging of the battery 209 is started, the screen of the tablet computer 20 is turned on by the above-described display auto-on function. In this case, the display controller 212 displays, for example, information to be presented to the user (hereinafter referred to as presentation information) on the screen (touchscreen display 22).

The information acquisition controller 213 acquires presentation information to be displayed on the screen when the screen of the tablet computer 20 is turned on as described above. The presentation information may be stored in the storage 214 in advance or may be acquired from, for example, various external servers or the like.

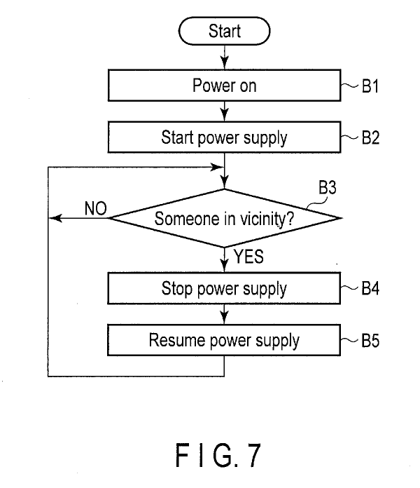

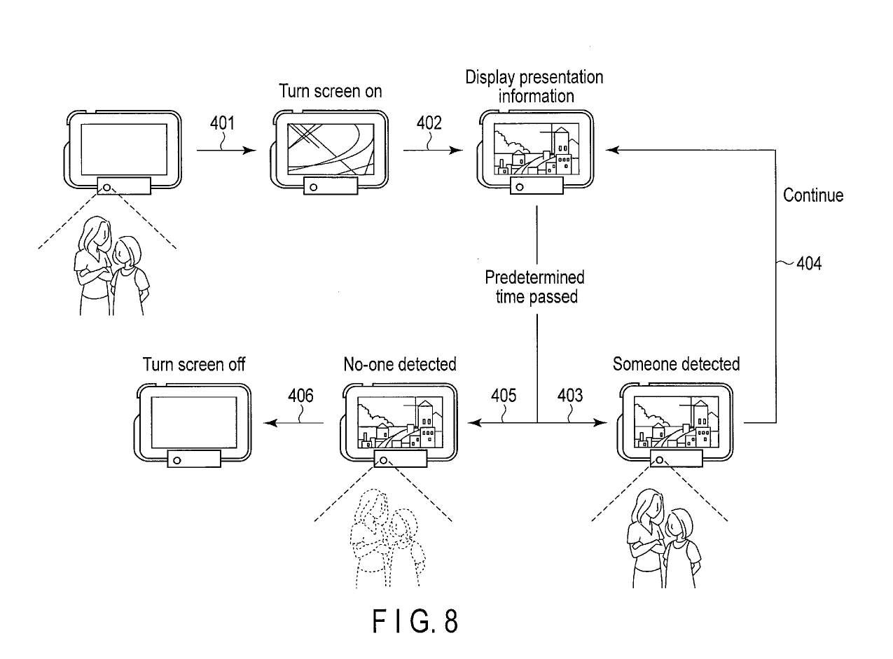

Next, with reference to the flowchart of FIG. 7, a procedure of the cradle 10 of the present embodiment will be described.

Here, when the tablet computer 20 is seated in the cradle 10 as described above, the switch 12b provided (on the upper surface of the seat 12 provided) in the cradle 10 is actuated. In this case, the cradle 10 is powered on (block B1).

When the cradle 10 is powered on, the power supply controller 111 included in the cradle 10 starts power supply to the tablet computer 20 (block B2).

When the power supply to the tablet computer 20 is started (that is, the charging of the battery 209 of the tablet computer 20 is started), in the tablet computer 20, the screen is automatically turned on by the above-described display auto-on function and presentation information is displayed on the screen.

Here, the presentation information to be displayed when the screen of the tablet computer 20 is automatically turned on by the display auto-on function includes, for example, a schedule (information) of the user of the tablet computer 20 registered in the tablet computer 20, an advertisement (information) of a company, a product, etc. and the like. Further, when an address or the like of the user is registered in the tablet computer 20, weather information and the like based on the address may be displayed as the presentation information, or information concerning traffic, crime prevention, disaster prevention and the like may be displayed as the presentation information. Still further, in order to keep an eye on a relative or the like living in a remote area, information about the relative uploaded to an external server (for example, a message from the relative, usage situation of a tablet computer or the like which the relative is using, health information of the relative registered in the tablet computer, and the like) may be displayed as the presentation information. Still further, the presentation information may be acquired from the storage 214 or may be acquired from an external server (cloud server) or the like when the presentation information is to be displayed on the screen of the tablet computer 20.

Note that this display of presentation information in the tablet computer 20 is realized when a computer (CPU 201) of the above-described tablet computer 20 executes an application program.

Here, when there is someone in the vicinity of the cradle 10, the above-described detector 112 can detect the presence of the person by the biopresence sensor 12c.

In this way, the controller 113 determines whether there is someone in the vicinity of the cradle 10 (that is, the presence of a person is detected by the detection module 112) or not (block B3).

When it is determined that there is someone in the vicinity of the cradle 10 (Yes in block B3), the controller 113 stops the power supply to the tablet computer 20 by the power supply controller 111 (block B4).

When a certain time (for example, about one second) has passed after the power supply to the tablet computer 20 is stopped in block B4, the controller 113 resumes the power supply by the power supply controller 111 (block B5).

If the screen of the tablet computer 20 is already on when the processing of block B5 is executed, the screen is kept on. On the other hand, If the screen of the tablet computer 20 is off when the processing of block B5 is executed, the screen is turned on.

In this way, it is possible to display presentation information on the screen of the tablet computer 20 when power supply to the tablet computer 20 is temporarily stopped and the power supply is subsequently resumed (that is, when charging of the battery 209 in the tablet computer 20 is resumed).

Once block B5 has been executed, processing returns to block B3.

Note that, when it is determined in above-described block B3 that there is no-one in the vicinity of the cradle 10 (No in block B3), processing of B4 and B5 will not be executed and processing of block B3 is executed again. That is, in the present embodiment, when there is no-one in the vicinity of the cradle 10, the power supply to the tablet computer 20 is maintained (continued). When the power supply to the tablet computer 20 is maintained in this way, the screen of the tablet computer 20 is automatically turned off by the above-described display auto-off function.

Note that, in the processing shown in FIG. 7, the processing of blocks B3 to B5 is repeatedly executed while the tablet computer 20 is seated in the cradle 10, and the following descriptions are given that the processing is executed at regular intervals determined on the basis of the above-described display timeout set in the tablet computer 20.

More specifically, with such a configuration as to execute processing of blocks B3 to B5 before the screen of the tablet computer 20 is turned off as the display timeout has occurred, it is possible to keep the screen of the tablet computer 20 on while there is someone in the vicinity of the cradle 10.

On the other hand, when there is no-one in the vicinity of the cradle 10, since processing of blocks B5 and B6 will not be executed, the screen of the tablet computer 20 can be automatically turned off.

Note that, when the tablet computer 20 is removed from the cradle 10, the switch 12b provided in the cradle 10 is released. In this case, the cradle 10 is powered off. That is, the processing shown in FIG. 7 ends at the time when the tablet computer 20 is removed from the cradle 10.

Further, in the present embodiment, presentation information is displayed on the screen of the tablet computer 20 when there is a person in the vicinity, and the person is not limited to the user of the tablet computer 20. Therefore, it is preferable that the presentation information to be displayed on the screen of the tablet computer 20 should not be the user's private and personal information.

With reference to FIG. 8, turning on and turning off (that is, a change between an on-state and an off-state) of the screen of the tablet computer 20 when the tablet computer 20 is seated in the cradle 10 of the present embodiment will be described.

Here, the following descriptions assume that the battery 209 of the tablet computer 20 is being charged while the tablet computer 20 is seated in the cradle 10 and the screen of the tablet computer 20 is off (that is, in a charging and stowed state).

In this case, when the presence of a person is detected in the vicinity of the cradle 10, as indicated by arrow 401 of FIG. 8, the screen of the tablet computer 20 is turned on.

When the screen of the tablet computer 20 is turned on in this way, as indicated by arrow 402 of FIG. 8, the above-described presentation information is displayed on the screen.

Here, the case indicated by arrow 403 of FIG. 8 where the presence of a person is detected in the vicinity of the cradle 10 after a predetermined time has passed will be described. In this case, control to temporarily stop power supply from the cradle 10 to the tablet computer 20 and subsequently resume the power supply is executed as described. Therefore, as indicated by arrow 404 of FIG. 8, the screen of the tablet computer 20 is kept on (that is, in a state in which the presentation information remains displayed).

In contrast, as indicated by arrow 405 of FIG. 8, a case where the presence of a person is not detected (that is, it is determined that no-one is present) in the vicinity of the cradle 10 after a predetermined time has passed will be described. In this case, power supply from the cradle 10 to the tablet computer 20 is maintained. Therefore, as indicated by arrow 406 of FIG. 8, the screen of the tablet computer 20 is turned off after the above-described display timeout has occurred.

In the present embodiment, as described above, when the presence of a person is detected in the vicinity of the cradle 10 while the cradle 10 is seated in the tablet computer 20, control to temporarily stop power supply for charging the battery 209 of the tablet computer 20 and subsequently resume the power supply is executed. According to the present embodiment, with this configuration, it becomes possible to automatically turn the screen of the tablet computer 20 on by the display auto-on function of the tablet computer 20 and to display presentation information on the screen. Therefore, according to the present embodiment, even when the user is charging the tablet computer 20 with no intention of displaying information, various kinds of information can be presented to the user, and thus it becomes possible to enhance the efficiency of the use of the tablet computer 20 (mobile device) and to expand the scope of the use of the tablet computer 20.

Further, in the present embodiment, while the presence of a person is detected in the vicinity of the cradle 10, control to temporarily stop power supply and subsequently resume the power supply is executed at regular intervals on the basis of the display timeout. According to the present embodiment, with this configuration, it is possible to keep the screen of the tablet computer 20 on (that is, a state in which the presentation information remains displayed) while there is someone nearby.

Further, in the present embodiment, while the presence of a person is not detected in the vicinity of the cradle 10, power supply is maintained. According to the present embodiment, with this configuration, the screen of the tablet computer 20 is automatically turned off by the display auto-off function when there is no-one in the vicinity of the cradle 10, and thus it is possible to reduce energy consumption by the tablet computer 20.

Note that, in the present embodiment, a case where the biopresence sensor 12c is used for detecting the presence of a person has been described, but another sensor or the like may be used for detecting the presence of a person.

More specifically, a configuration using a sensor capable of detecting opening and closing of the door of the room in which the cradle 10 is placed is also possible. With this configuration, when it is detected that the door is opened, this is regarded as entering of a person into the room, and thus the presence of a person can be detected. In this case, it is also possible to configure, for example, the cradle 10 by providing a communication module therein to receive the detection result by the sensor.

Further, a sensor capable of detecting the intensity of surrounding light (that is, turning on of a light or the like) may be used. That is, when it is detected that a light is turned on, this is regarded as the presence of a person in the vicinity, and thus detection can be performed in this manner as well. Still further, it is possible to detect the presence of a person by using a sensor (for example, a microphone or the like) capable of detecting the sound of the surroundings.

Still further, in the present embodiment, a case where the cradle 10 of the present embodiment is a desktop cradle has been described, but in the present embodiment, it is also possible to apply, for example, a wall-hung cradle designed to be hung on a wall of a room.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device detachably connected to a mobile device, the electronic device comprising:
a power supply configured to supply power to the mobile device when the mobile device is connected to the electronic device;
a detector configured to detect whether a user is within the detector's range; and
a controller configured to stop supplying power to the mobile device, when the detector detects a user while the mobile device is connected to the electronic device and to subsequently resume supplying power.

2. The electronic device of claim 1, wherein the mobile device comprises a function of turning a screen of the mobile device on and of displaying information, when supplying power is resumed.

3. The electronic device of claim 2, wherein the controller executes the control at regular intervals of a predetermined time while the detector detects a user.

4. The electronic device of claim 3, wherein the mobile device connected to the electronic device comprises a function of turning the screen off when a time set in the mobile device has passed after the screen of the mobile terminal is turned on, and the predetermined time is based on the time set in the mobile device.

5. The electronic device of claim 1, wherein the controller maintains supplying power to the mobile device while the detector detects no one.

6. A method executed by an electronic device detachably connected to a mobile device, the method comprising:
supplying power to the mobile device when the mobile device is connected to the electronic device;
detecting whether a user is within the detector's range; and
executing control to stop supplying power to the mobile device and to subsequently resume supplying power, when a user is detected while the mobile device is connected to the electronic device.
